(19) United States
(12) Patent Application Publication
(10) Pub. No.: US 2021/0308014 A1
(43) Pub. Date: Oct. 7, 2021

(54) INFANT DOSAGE DISPENSER

(71) Applicant: Nicholas Currlin, Gallatin, TN (US)

(72) Inventor: Nicholas Currlin, Gallatin, TN (US)

(21) Appl. No.: 17/215,495

(22) Filed: Mar. 29, 2021

Related U.S. Application Data
(60) Provisional application No. 63/005,576, filed on Apr. 6, 2020.

(51) Int. Cl. A61J 7/00; A61J 17/00

(52) U.S. Cl. CPC A61J 7/0053; A61J 2200/76; A61J 17/001

(57) ABSTRACT

An infant dosage dispenser for providing a safe one-piece dispensing vehicle in an infant pacifier nipple configuration. The dispenser has a nipple with a shaft and base formed of medical grade molded silicone synthetic resin forming a fluid retention chamber with contoured annular sidewall and integral interconnecting bottom. An access opening is formed for selective operation in the bottom of the base by deflection of a transverse self-sealing access slit there within.

This application claims the benefit of U.S. Provisional Application No. 63/005,576, filed Apr. 6, 2020.

### BACKGROUND OF THE INVENTION

### 1. Technical Field

This invention relates to infant and baby pacifiers and liquid dispensing nipples that allow infants to suck or bite. Such pacifiers and nipples for baby bottles are typically made from synthetic resin and silicone-based materials for their adaptability in such products that can be sanitized, cleaned and reused.

### 2. Description of Prior Art

Prior art infant fluid administration devices can be seen, for example, in U.S. Pat. Nos. 5,514,142, 5,601,605, 5,772,685 and 6,228,105.

In U.S. Pat. No. 5,514,142 a dispensing pacifier is disclosed having a nipple member with a cavity to receive a dispensing liquid and a flange closer stopper to seal same.

U.S. Pat. No. 5,601,605 claims an infant pacifier fluid administrating unit with a shield shaped body and a flexible nipple extending therefrom. An oppositely disposed fluid dispenser in communication therewith allows for fluid injection under applied pressure to the vessel.

U.S. Pat. No. 5,772,685 illustrates an infant pacifier fluid administrating device with a shield shaped body, a flexible nipple with a sucking orifice. The fluid dispenser having an outlet in communication with the nipple with a one-way valve element there between.

Finally, in U.S. Pat. No. 6,228,105 an infant pacifier with an attached rim defines a base which is secured together by sonic welding

### SUMMARY OF THE INVENTION

A fluid dosage dispenser for infants has a contoured body member with an integrated integral upstanding fluid dispensing nipple formed thereon and in communication with a fluid receiving chamber formed by the nipple support body member base. A self-sealing fluid filled access opening formed within the base provides for selective access thereto under translateral deflection of the base along the lateral axis of the access slit opening.

### DESCRIPTION OF THE DRAWINGS

FIG. 1 is a perspective view of the infant dosage dispenser of the invention.

FIG. 2 is a side elevational view thereof.

FIG. 3 is a bottom plan view thereof.

FIG. 4 is a cross-section on lines 4-4 of FIG. 1.

FIG. 5 is a bottom plan view under translateral force deflection defining opening of the access slit in the bottom.

FIG. 6 is a perspective view of the infant dosage dispenser under forced deflection to open the self-sealing access slit shown in broken lines.

FIG. 7 is a perspective view of an alternate form of the invention.

FIG. 8 is a side elevational view thereof.

FIG. 9 is an enlarged cross-sectional view thereof.

FIG. 10 is a perspective view of the alternate infant dosage dispenser under forced deflection to open self-sealing access slit on its contoured upper side surface.

### DETAILED DESCRIPTION OF THE INVENTION

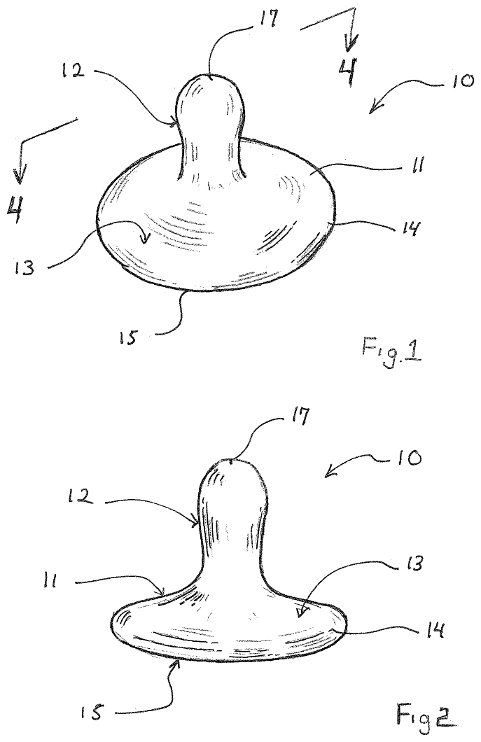

Referring to FIGS. 1-4 of the drawings, an infant dosage dispenser 10 of the invention can be seen having a base portion 11 with an upstanding hollow nipple 12 extending therefrom. The base portion 11 is of an annular contoured configuration with a top surface 13 and a continuous curve depending sidewall 14.

An integral bottom 15 extends from the sidewall 14 defining a hollow chamber 16 there within, as best seen in FIG. 4 of the drawings. The base portion 11 and nipple 12 are preferably made of a medical grade synthetic resin resilient elastomeric material such as silicone which provides a yielding pliable surface while maintaining a cohesive structure shape once so formed.

The hollow nipple 12 has a top centered opening at 17 as is found fluid dispensing nipples known within the art that are adaptable to infants, not shown, oral engagement and sucking to draw out the contents of a container, not shown, which is typically attached to the nipple for on demand access by the infant.

The base portion 11 and integral nipple 12, as noted, form a one-piece structure so as configured in this application as an infant pacifier shape.

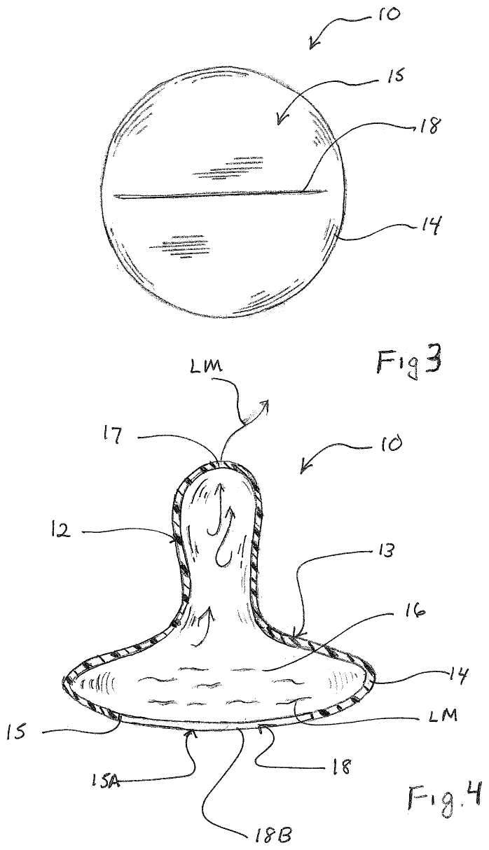

A chamber access opening 18 is provided in the bottom 15's surface 15A extending transversely along a center line, as best seen in FIGS. 3 and 4 of the drawings. The access opening 18 is of a self-closing slit configuration with a corresponding effacing abutting edges 18A and 18B that maintain a self-sealing engagement there between at rest due to the silicone's memory and surface yielding properties imparted in part by the contoured annular shape of the base defined chamber 16.

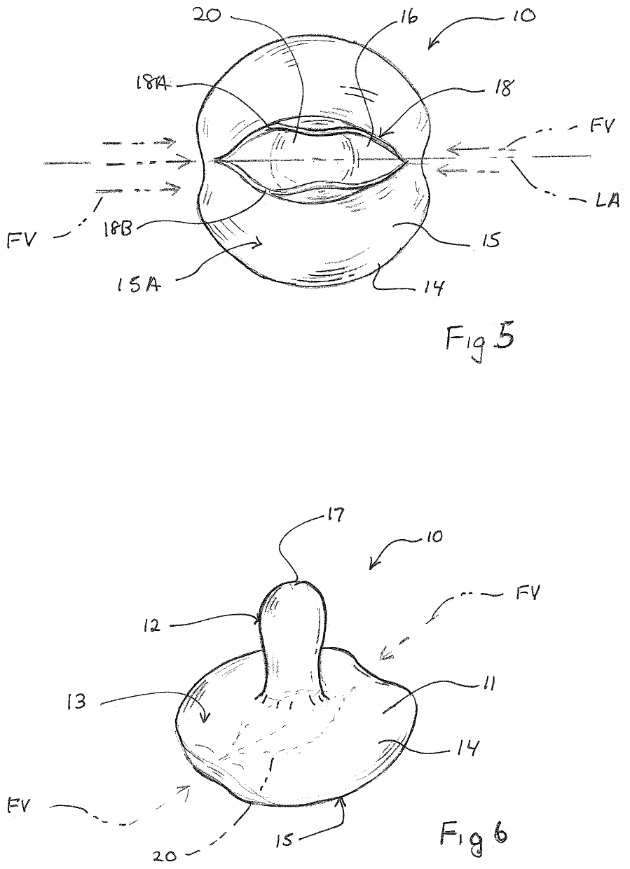

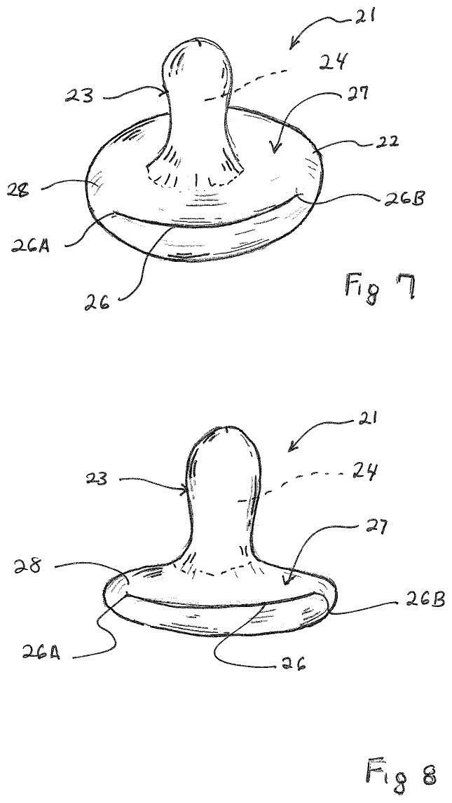

Referring now to FIGS. 3, 5 and 6 of the drawings, the dosage dispenser 10 of the invention can be seen in open position with the access opening 18 slit configuration deflected along its longitudinal axis LA by application of opposing force vector against the annular sidewall 14 in alignment with the access opening 18 slit illustrated by directional arrows FV.

As it will be seen, that by applying oppositely disposed force thereto by a user, not shown, the access opening slit 18 will thereby distort translaterally forming an opening at 20 to the hereinbefore defined chamber 16.

The respective bottom surfaces adjacent the access opening 18 slit will thereby distort and distend vertically as seen in FIGS. 3, 5 and 6 of the drawings in both solid and broken lines. This orientation will allow for the filling of the chamber 16 with liquid medication LM, as required, Once released, the access opening 18 slit will close self-sealing and provide a liquid proof seal against the contents within the chamber 16 illustrated best in FIGS. 1 and 4 of the drawings.

In use, once filled, the chamber 16 of the infant dosage dispenser 10 will provide a liquid reservoir of chosen medication LM. The nipple 12 is so engaged by the infant, not shown, and thereby receive the medication LM through the nipple 12 in a metered measured amount while sucking on the pacifier configured infant dosage dispenser of the invention.

Referring now to FIGS. 7-10 of the drawings, an alternate form of the invention can be seen having a modified infant dosage dispenser 21 with a contoured base portion 22 and upstanding nipple 23 integrally extending therefrom. While the base portion 22 is hollow as in the primary form of the invention, the nipple 23 in the alternate form is filled with a porous synthetic foam material 24 to provide a yielding rigidity to the nipple 23 while still allowing liquid fluid flow there through.

A hollow fluid receiving and retention chamber 25 is formed within the base 22 and allows for integral fluid transfer from the base chamber 25 into the foam filled nipple 23.

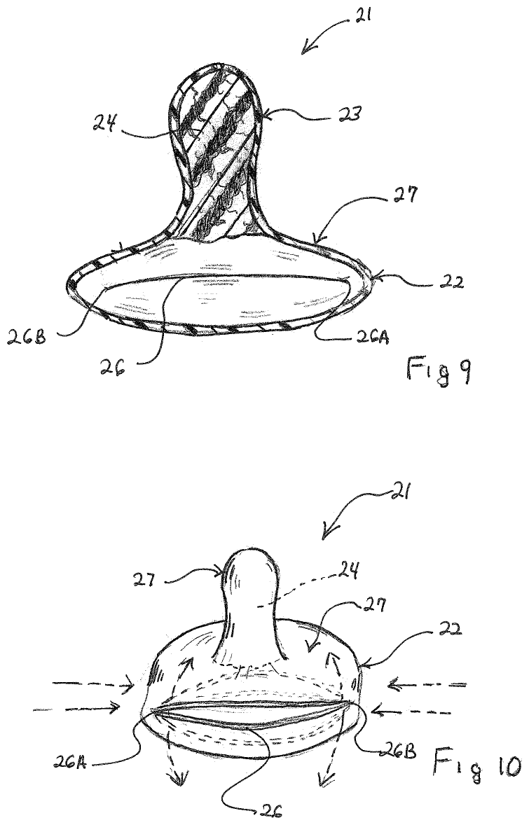

A self-closing and sealing access opening 26 is formed translaterally across the upper mid portion of the top defined surface 27 of the base portion 22 and correspondingly on the continuous curved depending sidewall 28, best seen in FIGS. 9 and 10 of the drawings.

As set forth in the primary form of the infant dosage dispenser 10, the access self-sealing opening 26 is activated by oppositely disposed user, not shown, applied force adjacent the access opening's respective end terminations 26A and 26B indicated by applied force arrows FA deflecting the engaged surfaces as indicated generally in FIG. 10 of the drawings.

It will be evident that the self-sealing access opening 26's dimension will increase based on the opposing applied pressure so as to allow easy access to the chamber 25 to be filled with any suitable infant medication required. Once released, the access opening 26 will close and seal and fluid medication dispensing will be selectively provided through the porous foam filled nipple 23 to be engaged by the infant as hereinbefore described.

Given the all-inclusive one-piece design and material, the dispenser is easy to use and clean and maintain a sterile field as required.

It will thus be seen that a new and novel infant dosage dispenser in the form of a pacifier configuration has been illustrated and described and it will be apparent to those skilled in the art that various changes and modifications may be made therein without departing from the spirit of the invention. Therefore, I claim:

1. An infant dosage dispenser comprising,
an upstanding nipple and a contoured fluid receiving base extending therefrom,
a self-sealing fluid access opening in said base,
a fluid dispensing opening in said nipple,
said fluid dispensing opening in top center position of said nipple.

2. The infant dosage dispenser set forth in claim 1 wherein said nipple is hollow and in direct communication with said fluid receiving base.

3. The infant dosage dispenser set forth in claim 1 wherein said fluid receiving base is deformable from a fluid shaped retaining closed position to a fluid receiving open position.

4. The infant dosage dispenser set forth in claim 1 wherein said self-sealing fluid access opening in said base comprises,
an elongated slit in said base in oppositely disposed relation to said opening in said nipple.

5. The infant dosage dispenser set forth in claim 3 wherein said receiving base fluid receiving open position comprises,
deforming oppositely disposed sides of said contoured base opening said self-sealing fluid access opening.

6. The infant dosage dispenser set forth in claim 1 wherein said base has a top portion, annularly depending integral sidewalls and an interconnecting bottom surface.

7. The infant dosage dispenser set forth in claim 6 wherein said base top portion extends integrally from said upstanding nipple defining a contoured annular base.

8. An infant dosage dispenser comprising,
a contoured fluid receiving base having a contoured top portion, an upstanding nipple extending centrally from said top portion,
said upstanding nipple filled with porous synthetic foam,
said contoured fluid receiving base is hollow,
a self-sealing fluid access opening in said contoured top portion in spaced relation to said foam filled nipple.

9. The infant dosage dispenser set forth in claim 8 wherein said contoured annular base is deformable from a first annular fluid receiving retaining closed portion to a fluid receiving open position.

10. The infant dosage dispenser set forth in claim 8 wherein said contoured fluid receiving base contoured top portion extends from said upstanding nipple,
an integral depending annular sidewall extends from said contoured top portion having an interconnected solid bottom surface.

11. The infant dosage dispenser set forth in claim 9 wherein said fluid access opening in said top portion comprises,
a slit extending translaterally across said contoured top portion deformable by applied pressure to said integral depending annular sidewalls in oppositely disposed relation thereto.
